(19) United States
(12) Patent Application Publication
(10) Pub. No.: US 2007/0249343 A1
(43) Pub. Date: Oct. 25, 2007

(54) Method and system of communications

(76) Inventors: Andreas Olsson, Stockholm (SE); Krister Sundberg, Sollentuna (SE); Orjan Sjelvgren, Hasselby (SE); Peter Oskar Olof Bjorken, Solna (SE)

Correspondence Address: ERICSSON INC., 6300 LEGACY DRIVE, M/S EVR 1-C-11, PLANO, TX, 75024, US

(21) Appl. No.: 11/736,843

(22) Filed: Apr. 18, 2007

Related U.S. Application Data
(60) Provisional application No. 60/745,136, filed on Apr. 19, 2006.

(51) Int. Cl. H04Q 7/20

(52) U.S. Cl. 455/435.1

(57) ABSTRACT

The present invention relates to cellular mobile radio systems, and more especially it relates to reduction of communications latency. Particularly, it relates to transmissions of (positive or negative) acknowledgments. Queuing or redundancy is reduced by means of signaling comprising information on the positive or negative acknowledgements.

### CROSS-REFERENCE TO RELATED APPLICATIONS

This application claims the benefit of U.S. Provisional Application No. 60/745136, filed Apr. 19, 2006, the disclosure of which is incorporated herein by reference.

### TECHNICAL FIELD OF THE INVENTION

The present invention relates to cellular mobile radio systems, and more especially it relates to communications latency reduction and capacity increase. Particularly, it relates to transmissions of (positive or negative) acknowledgments.

### BACKGROUND AND DESCRIPTION OF RELATED ART

Global System for Mobile communications, GSM, Enhanced Data rates for Global Evolution, EDGE, general packet radio systems, GPRS, and enhanced GPRS, EGPRS are example prior art radio communication systems.

3rd Generation Partnership Project (3GPP): Technical Specification Group GSM/EDGE Radio Access Network, General Packet Radio Service (GPRS), Mobile Station (MS)-Base Station System (BSS) interface, Radio Link Control/Medium Access Control (RLC/MAC) protocol, 3GPP TS 04.60 VB.27.0, France, Sep. 2005, specifies the procedures used at the radio interface (Reference Point Um, see 3GPP TS 04.02) for the General Packet Radio Service (GPRS) Medium Access Control /Radio Link Control (MAC/RLC) layer.

The technical specification comprises in respective sections 10.3a.3 and 10.3a.4 downlink and uplink block headers for various modulation and coding schemes, MCSes, used for EGPRS as illustrated for the uplink in FIGS. 1, 2 and 3. FIG. 1 corresponds to MCSes 1-4; FIG. 2 corresponds to MCSes 5 and 6, and FIG. 3 corresponds to MCSes 7-9.

In the 3GPP technical specification, an RR connection is a physical connection established between a mobile station and the network to support the upper layers' exchange of information flows. An RR connection is maintained and released by the two peer entities. A Temporary Block Flow, TBF, is a physical connection used by the two RR peer entities to support the unidirectional transfer of LLC PDUs Logical Link Control Protocol Data Units) on packet data physical channels. The TBF is identified by a temporary flow identifier, TFI, together with, in case of an RLC data block, the direction (uplink or downlink) in which the RLC data block is sent; and in case of an RLC/MAC (Radio Link Control/Medium Access Control) control message, the direction in which the RLC/MAC control message is sent and the message type. Global TFI is used to unambiguously identify the mobile station during packet transfer mode in an uplink or downlink RLC/MAC control message. If present, the Global TFI addresses the mobile station, MS, using either the uplink TFI or downlink TFI of the MS. Which TFI is used is at the discretion of the sender except where explicitly defined by procedure. The stall indicator, SI, bit indicates whether the mobile's RLC transmit window can advance (i.e., is not stalled) or can not advance {i.e., is stalled). The mobile station shall set the SI bit in all uplink RLC data blocks. The Retry bit, R, shall indicate whether the mobile station has transmitted a CHANNEL REQUEST message. If the mobile station has sent the CHANNEL REQUEST message once, R equals 0. If the mobile station has sent the CHANNEL REQUEST message twice or more, R equals 1.

For EGPRS, each RLC data block contains a block sequence number, BSN, field that is 11 bits in length. At the time that an in-sequence RLC data block is designated for transmission, the value of BSN is set equal to the value of a send state variable V(S). In EGPRS header, the Coding and Puncturing Scheme, CPS, indicator field is used to indicate the kind of channel coding and puncturing used for data blocks. A PFI Indicator, PI, indicates the presence of the optional packet flow identifier, PFI, field. The Resent Block Bit, RSB, indicates whether any of the RLC data blocks contained within the EGPRS radio block have been sent previously.

FIGS. 4, 5 and 6 are RLC/MAC headers for the downlink corresponding to the MCSes of FIGS. 1, 2 and 3, respectively.

The RRBP value specifies a single uplink block in which the mobile station shall transmit either a PACKET CONTROL ACKNOWLEDGEMENT message or a PACCH block to the network, where PACCH is a Packet Associated Control Channel. According to prior art there are two bits reserved for RRBP, defining four possible values.

In case two RLC data blocks are sent within an RLCIMAC block, BSN2 is relative to BSN1, provided the difference between the second block number and the first block modulo SNS is less than Window Size (WS), where SNS is Sequence Number Space, which is equal to 2048 in EGPRS, and 128 in GPRS. This holds for both uplink and downlink blocks.

The Power Reduction, PR, field indicates the power level reduction of the current RLC block.

The ES/P field is used to indicate whether the RRBP field is valid or not valid, and what fields the next uplink control block shall contain. The mobile station, MS, responds to a downlink ES/P in accordance with FIG. 7, illustrating the various ES/P field settings according to the 3GPP technical specification for the uplink direction. NPB and FPB denotes Next and First Partial Bitmap, respectively. FPB and NPB are specific instances of the EGPRS Ack/Nack Description Information Element within a Packet Downlink Ack/Nack message.

Time slots are numbered cyclically e.g. 0, 1, 2, 3, 4, 5, 6, 7, 0, 1, 2 . . . A USF (Uplink State Flag) field is sent in all downlink RLCIMAC blocks and indicates the owner or use of the next uplink radio block on the same timeslot number.

In EGPRS, the Split Block indicator is used in header type 3 to indicate if some user data is retransmitted using 2 10 block resegmentation.

Received protocol data units are (positively or negatively) acknowledged by means of positive/negative acknowledgements, ACKs/NACKs. The ACK/NACK reporting is sent in separate packets or messages in which no data payload can be included.

None of the cited documents above discloses transmission of signaling information reducing queuing or overall redundancy associated with ACK/NACK transmissions or inclusion of ACK/NACK reports in data block part maintaining backward compatibility.

### SUMMARY OF THE INVENTION

A sending entity comprises one or more buffers to efficiently utilize transmission resources and accommodate to available transmission and processing capacities.

When there is payload data in a send buffer, prior art solutions prohibit sending of such data if an ACK/NACK report is scheduled for sending. This introduces delay and latency and reduces user performance satisfaction.

It is, consequently, an object of preferred embodiments of the invention to provide a method and system of (positive or negative) acknowledgement transmissions harmonized with payload transmissions.

Also, an object of preferred modes of the invention is to provide a method and system that improves RLC/MAC header structure.

An object of one mode of the invention is to provide a method and system reducing delay or latency.

Further, an object of embodiments of the invention is to provide a method and system of improved performance facilitating legacy operations.

Finally, an object of an embodiment of the invention is to provide a method and system of including ACK/NACK in PDCH 15 uplink or downlink block with payload data part.

These objects are met by a method and system of including piggybacking of ACK/NACK data.

Preferred embodiments of the invention, by way of examples, are described with reference to the accompanying drawings below.

### BRIEF DESCRIPTION OF THE DRAWINGS

FIG. 1 illustrates first uplink block headers according to prior art specifications.

FIG. 2 illustrates second uplink block headers according to prior art specifications.

FIG. 3 illustrates third uplink block headers according to prior art specifications.

FIG. 4 illustrates first downlink block headers according to prior art specifications.

FIG. 5 illustrates second downlink block headers according to prior art specifications.

FIG. 6 illustrates third downlink block headers according to prior art specifications.

FIG. 7 illustrates various ES/P field settings according to prior art for the uplink direction.

FIG. 8 depicts schematically a non-exclusive example flow chart illustrating an embodiment of the invention.

FIG. 9 demonstrates a preferred RRBP header field for signaling according to the invention.

FIG. 10 illustrates a preferred AN header field for signaling according to the invention.

FIG. 11 illustrates elements of a communications entity according to the invention.

### DESCRIPTION OF PREFERRED EMBODIMENTS

The invention discloses amendments of protocols and signaling, reducing or eliminating delay. Further, the invention provides faster retransmission and less redundancy.

The invention covers both downlink ACKINACK reporting (feedback information transmitted in uplink direction) and uplink ACKINACK reporting (feedback information transmitted in downlink direction).

Downlink ACK/NACK reporting

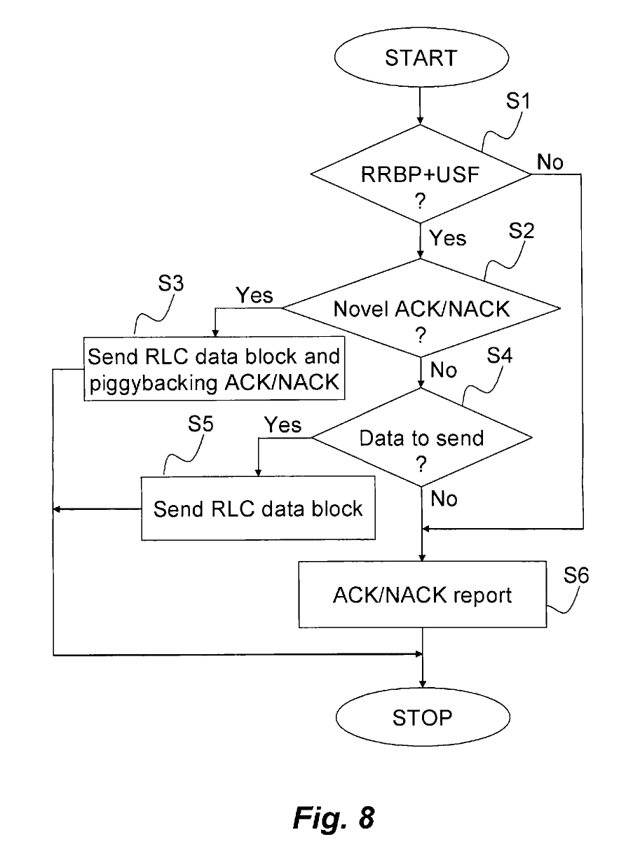

FIG. 8 depicts schematically a non-exclusive example flow chart illustrating an embodiment of the invention. In the example now chart RRBP and USF fields are used as preferred example fields for demonstrating the invention. However, the invention does not exclude other fields, e.g. BSN or PR. to be deployed correspondingly. User equipment receiving one or more downlink RLC data blocks checks the header of a first RLC data block <<S1>>. If the header of the first RLC data block comprises a valid RRBP and the USF in a second RLCIMAC block comprises the same uplink block period as identified in the RRBP, there are two possible alternatives for further consideration <<S2>>. If the USF in the second RLC/MAC block does not comprise the same uplink block period as identified in the RRBP <<S1>>, piggybacking is not further considered and a legacy ACK/NACK report message is transmitted in accordance with prior art specifications <<S6>>.

If the header of the first RLC data block did comprise a valid RRBP field and the USF in the second RLC/MAC block comprises the same uplink block period as identified in the RRBP, a piggybacking ACKINACK report is sent <<S3>>, provided that also a previously sent downlink RLC data block was received in error but has not earlier been reported as erroneous (i.e. negatively acknowledged), or a downlink RLC data block was received correctly, the earlier transmission(s) of which was negatively acknowledged.

If there is no novel ACK/NACK status, as described above, a legacy RLC data block message will be sent <<S5>> if there is data to send <<S4>>, and if there is no data to send <<(S4>>, a legacy ACK/NACK report message is transmitted <<S6>>).

According to a first mode of the invention, in accordance with the flow chart in FIG. 8, the network is in control of the reporting and particular messaging. This provides for backward compatibility with legacy mobile stations/user equipment. According to a first alternative mode the ordering of steps <<S2>>, <<S4>> after the step of detecting a USF field (<<S1>> are interchanged. Associated transmitted messages (<<S3>>, <<S5>>are interchanged correspondingly.

In an second mode of the invention, detection of a USF field (as in FIG. 8 <<S1>>), induces mobile station/user equipment operating in accordance with the invention to determine which particular message type to send, and when it should be sent, when the mobile station/user equipment is USF scheduled.

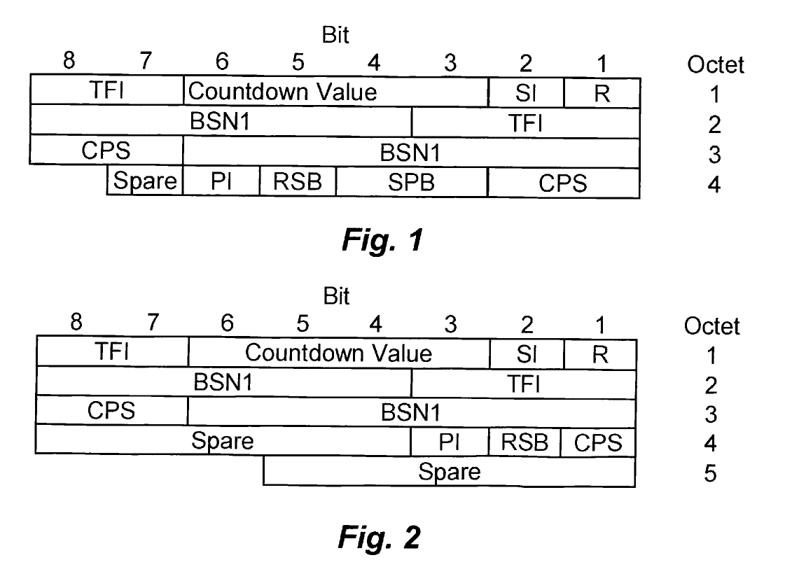

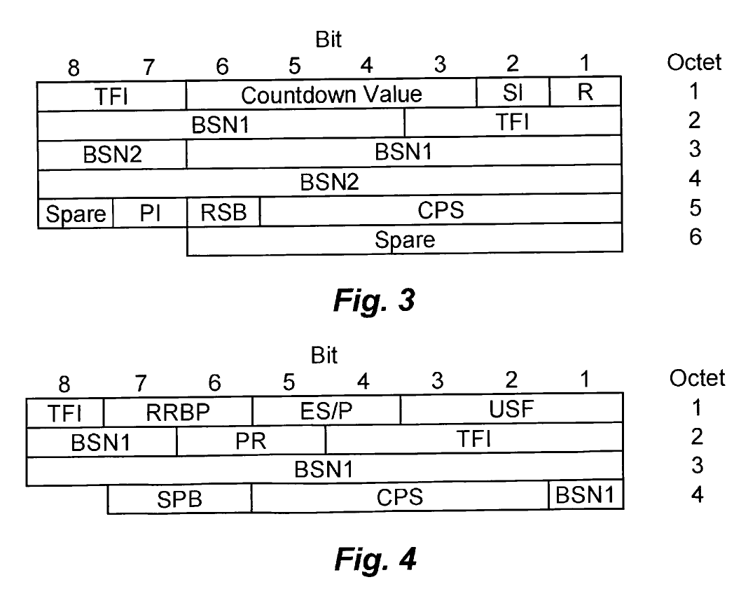

For all three modes, a particular bit is included among the spare bits of the EGPRS uplink RLC data block header. This is compliant with existing 3GPP technical specification (see FIGS. 1-3). Thereby, the uplink receiving node can determine whether the received data block comprises piggy-backing ACK/NACK information. The RLC data block is des-tined for Base Station Controller or Serving/Gateway GPRS Support Node, SGSN/GGSN, and has to pass radio base stations. By incorporating the piggybacking information in existing RLC/MAC header structure, intermediary nodes are not required to be upgraded for implementation of the invention. Spare bits are available for all three uplink RLC data block types. Backward compatibility of the invention, consequently, also embraces radio access network nodes such as radio base stations.

According to the invention positive or negative acknowledgements, ACKs/NACKs, are included in uplink RLC/MAC packets, preferably in the data part.

Piggybacking ACK/NACK messages are accompanied by inclusion of an ACK/NACK information field, AN, in the EGPRS RLCIMAC downlink feedback header (transmitted in uplink direction). Thereby, piggybacking ACK/NACK messages can be distinguished from payload data, There is preferably a corresponding AN field for the uplink reporting (see below).

A USF may be allocated immediately before an ACK/NACK report is transmitted. Preferably, the mobile station/user equipment prepares ACKINACK reports both for piggybacking and for inclusion in dedicated messages, at least unless a USF is received well before the transmission of the ACK/NACK. Also preferably the respective ACK/NACK reports for piggy-backing and for inclusion in a dedicated message are different. The ACK/NACK report for piggybacking is preferably a short bitmap. whereas the ACK/NACK report preferred for inclusion in a dedicated ACK/NACK report message is a either a full report. Also preferably, ACK/NACK reports for piggybacking are provided additional error protecting coding in comparison with the error protecting coding of payload data. However neither of the report formats are excluded for either of the reports.

For piggybacking ACK/NACK reports also the location of the ACK/NACK report within the RLC data block should be known at the receiving end.

A predefined location is very convenient as it does not need to be communicated for each RLC data block. Once defined the position is implicitly known by both sides and could be applied for a plurality of RLC data blocks. A pre-defined location does not exclude that it could be redefined as need be. The pre-defined location could be relative to a particular position of the RLC data block message, e.g. the end of the RLC data block.

The one or more particular BSNs acknowledged (positively or negatively) is preferably referred to in the ACKINACK report by absolute reference or relative address.

Uplink ACKINACK reporting

According to the invention, prior art RRBP field is re-placed by an RRBP field and an ACK/NACK indicator, AN, field in the EGPRS downlink RLC/MAC headers. The AN field comprises information on whether a piggybacking ACK/NACK is included or not.

A mobile station/user equipment according to the invention identifies whether or not an ACK/NACK report is included in the data payload part of an RLC data block from the information content of the AN field.

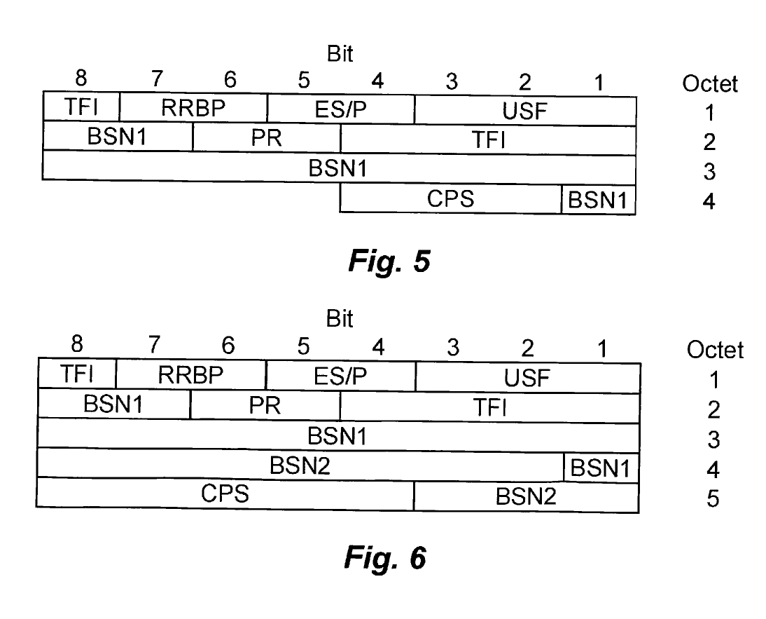

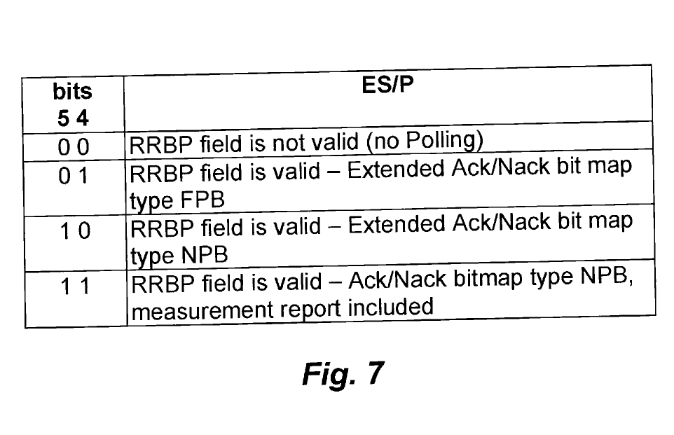

As an alternative to replacing prior art RRBP field to provide the AN field, the prior art ES/P field could be replaced (see FIGS. 4-6). The AN field is preferably positioned in the intermediary of the RRBP and ESIP fields as replaced.

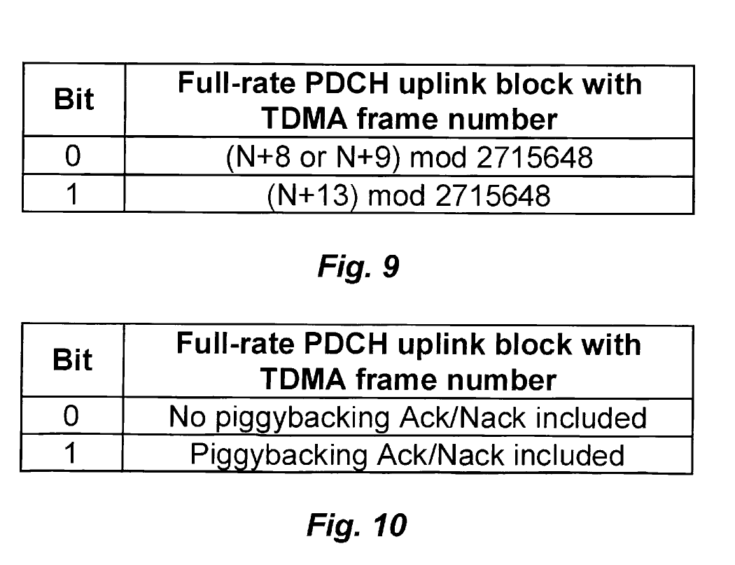

The replacing RRBP field preferably defines two possible values, 20 ms or 40 ms, as illustrated in the example in FIG. 9. For explanation of the figure but unimportant to the invention, the delay in FIG. 9 is relative to the first TDMA frame, N, of the downlink block containing the RRBP value.

For RRBP value 0, there are two TDMA frame numbers indicated. the frame number used depending on in which block the RRBP was sent due to intermediary IDLE and PTCCH (Packet Timing Advance Control Channel) frames according to the technical specifications of GPRS and EGPRS.

As an alternative or complement to RRBP, the ES/P field is replaced to accommodate an AN field.

FIG. 10 illustrates the preferred AN field according to the invention. There are two alternatives indicated piggybacking ACK/NACK report or no piggybacking ACK/NACK report. The invention covers both positive and negative logic in relation to the inclusion of a piggybacking ACK/NACK report.

As discussed in relation to downlink ACK/NACK reporting, the location of a piggybacking ACK/NACK report should be identical at both transmitting side and receiving side.

A pre-defined location is very convenient as it does not need to be communicated for each RLC data block. Once defined the position is implicitly known by both sides and could be applied for a plurality of RLC data blocks. A pre-defined location does not exclude that it could be redefined as need be. The pre-defined location could be relative to a particular position of the RLC data block message, e.g. the end of the RLC data block.

The one or more particular BSNs (positively or negatively) acknowledged is preferably referred to in the ACK/NACK report by absolute reference or relative address.

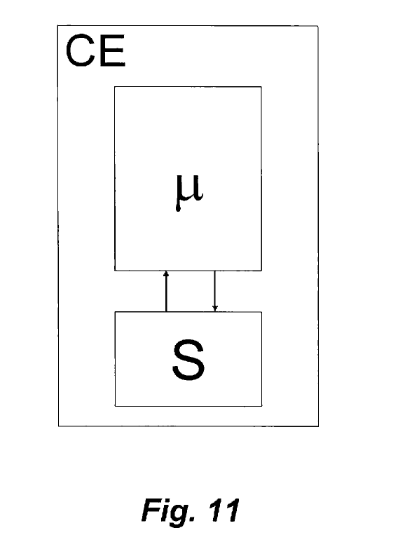

FIG. 11 illustrates elements of a communications entity according to the invention. The communications entity comprises processing means <<μ>>and storing means <<S>>. The processing means are adapted for formatting headers to be transmitted and interpreting headers received, and also for inclusion of ACK/NACK reports in data blocks with payload data as described above. The processing means <<μ>> are further preferably adapted to determine how and in which cases to include AN header information and piggybacking ACK/NACK reports, as is preferably stored in storing means <<S>>.

A person skilled in the art readily understands that the receiver and transmitter properties of an AP or user equipment are general in nature. The use of concepts such as AP, MS or RBS within this patent application is not intended to limit the invention only to devices associated with these acronyms. It concerns all devices operating correspondingly, or being obvious to adapt thereto by a person skilled in the art, in relation to the invention. As an explicit non-exclusive example the invention relates to mobile stations without a subscriber identity module, SIM, as well as user equipments including one or more SIMs.

The invention is not intended to be limited only to the embodiments described in detail above. Changes and modifications may be made without departing from the invention. It covers all modifications within the scope of the following claims.

1. A method of transmitting positive or negative acknowledgements in a radio communications system between an access point and user equipment, the method comprising the step of:
signaling information on positive or negative acknowledgements within a data block,

2. The method according to claim 1, wherein the positive or negative acknowledgments are included in RLC data blocks.

3. The method according to claim 1, wherein the positive or negative acknowledgments are represented in shortened reports.

4. The method according to claim 3, further comprising the step of referring to one or more acknowledged messages or BSNs in the positive or negative acknowledgement reports by an absolute reference or relative address.

5. The method according to claim 1, wherein the positive or negative acknowledgments are provided additional forward error control coding when compared to forward error control coding provided to payload data.

6. The method according to claim 1, further comprising the step of using an information field that indicates whether the positive or negative acknowledgements are included with payload data.

7. The method according to claim 1, wherein the positive or negative acknowledgments are transmitted if there is a novel acknowledgement status.

8. The method according to claim 1, wherein the positive or negative acknowledgments are transmitted if there are RRBP and USF fields with the same uplink block period.

9. A signal format adapted for radio transmissions of positive or negative acknowledgements in a radio communications system between an access point and user equipment, the signal format comprising a header field with an acknowledgement indicator indicating whether a data block message includes additional acknowledgment information.

10. The signal format according to claim 9, wherein the signal format is adapted for inclusion of both acknowledgement reporting and payload data, where the acknowledgment reporting can be positive or negative.

11. The signal format according to claim 9, wherein the acknowledgment indicator field is included in a first octet of the header field.

12. The signal format according to claim 9, wherein the acknowledgment indicator is included in the header field proximate to an RRBP or a USF field.

13. The signal format according to claim 9, wherein the signal format is adapted for controlling reporting and messaging.

14. A communication entity comprising a processor for processing a signal with positive or negative acknowledgements included within a data block.

15. The communication entity according to claim 14, wherein the positive or negative acknowledgments are included in RLC data blocks.

16. The communication entity according to claim 14, wherein the positive or negative acknowledgments are represented in shortened reports.

17. The communication entity according to claim 16, wherein one or more acknowledged messages or BSNs are referred to in the positive or negative acknowledgement reports by an absolute reference or relative address.

18. The communication entity according to claim 14, wherein the positive or negative acknowledgments are provided additional forward error control coding when compared to forward error control coding provided to payload data.

19. The communication entity according to claim 14, wherein an information field indicates whether the positive or negative acknowledgements are included with payload data.

20. The communications entity according to claim 14, wherein the communications entity being anyone of the following:
user equipment;
a mobile station;
a control node in a radio access network;
a base station controller; or
a GPRS support node.
